(19) United States
(12) Patent Application Publication
(10) Pub. No.: US 2007/0065223 A1
(43) Pub. Date: Mar. 22, 2007

(54) Writing instrument having lenticular display surface

(76) Inventors: Steven A. Singer, Prior Lake, MN (US); Dominic D. Santa Maria, Gloversville, NY (US); Daniel A. Eke, Andover, MN (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 11/228,112

(22) Filed: Sep. 16, 2005

(51) Int. Cl. B43K 23/02; B43K 29/00

(52) U.S. Cl. 401/131; 401/195

(57) ABSTRACT

A writing instrument is provided that includes an elongated body having a length, an outer surface, a proximal end, and a distal end, and a clip extending along at least a portion of the length of the body. The clip includes an outwardly facing display surface with a lenticular image. The display surface can include a lenticular lens material insert positioned on a base portion of the clip and the lenticular lens material insert can be removably attached to the base portion of the clip, such as with at least one retaining clip. Alternatively, the lenticular lens material insert can be permanently attached to the clip.

### TECHNICAL FIELD

The present invention relates to writing instruments having a surface for displaying an image. More particularly, the invention relates to a lenticular image displayed on the pocket clip of a writing instrument.

### BACKGROUND OF THE INVENTION

Writing instruments often consist mainly of an elongated barrel portion having an interior volume for containing an ink product or another marking material and also an outer surface for grasping by the user when writing or otherwise transferring the marking material to another substance. For example, the writing instruments can include pens, pencils, markers, highlighters, and the like, which contain materials such as ink, lead, or the like that can be used to write, draw, or otherwise express information on a substance. The number of combinations of writing instruments, marking materials, and medium to which the marking materials can be transferred is nearly limitless, and new instruments and materials are continually being developed and improved. Thus, writing instruments are used widely in nearly every type of industry, in almost every home, and by people having all types of lifestyles and incomes.

A product with exposure that is this far-reaching has provided an excellent source of advertising for companies. The advertising can consist of printing a company logo on the outer surface of a writing instrument barrel, then distributing the writing instrument to customers or other people to whom it is desired to convey a message. Because such a writing instrument will typically be used a number of times before the writing material is depleted, a single writing instrument having advertising messages can reach the same customer or different customers a large number of times. For example, a drug manufacturer may print the name of a new medication on the outer surface of a pen barrel, then distribute the pen to health care providers, patients, and pharmacists. In this way, the people who receive the pen will be provided with a useful writing instrument on which they will see the name of the medication each time they look at the pen, such as when it is sitting on a desk surface. Another type of advertising that may be provided on the outside of a writing instrument barrel includes information relating to the product name and/or manufacturer of the writing instrument itself. This information can be useful as a reminder for future purchases of the writing instrument and refills, and also can influence an initial purchase of the writing instrument (e.g., the outer barrel includes visually appealing graphics containing product information).

Writing instruments often also include a pocket clip that extends from the outer surface of the barrel. These clips are often used to retain the writing instrument in a user's pocket or to secure the writing instrument to another material, such as a pad of paper. Pocket clips are typically provided in the form of an elongated structure that has a first end that is stationary relative to the outer surface of a writing instrument barrel and a second end that is adjacent to but not attached to the barrel. The portion of the clip between the first and second ends is typically spaced at least slightly from the outer surface of the barrel, with the second end of the clip being biased toward the barrel. In this way, the barrel of the writing instrument can be placed inside the pocket of a user with the pocket clip slipped over the fabric of the pocket so that it is positioned outside the pocket. The bias of the second end of the clip can allow the clip to move at least slightly away from the barrel to accommodate the width of the pocket fabric, for example, yet provide an attachment to the fabric.

In some cases, a pocket clip can also be used to display information on its outwardly facing surface or to provide a surface having a particular functional use. For example, U.S. Pat. No. 3,590,441 (Goldberg) provides an emblem attachment device for use with pocket clips that is used for mounting desired 3-dimensional emblems and the like to present a particular appearance for a pocket clip. For another example, U.S. Pat. No. 6,001,082 (Dair et al.) provides a medication delivery pen having a pocket clip with a magnifying portion to better view dosage numerals. While such exemplary uses for a pocket clip are beneficial, there are opportunities to utilize the outwardly facing surface of pocket clips for displaying information in different manners.

### SUMMARY OF THE INVENTION

The present invention provides a writing instrument having an extending clip or pocket clip with a surface that utilizes lenticular lens materials for display purposes, such as for displaying advertising information and/or graphics. Such a use of lenticular material allows for a visually interesting and changeable display of information, which can improve the visual appeal of the surface. That is, lenticular lens material has the capability to exhibit a desired visual effect, such as flipping of the image, zooming in or zooming out of a particular image, 3-D or stereographic effects, full motion video or movement of an image, “morphing” or an illusion of metamorphosis from one image to another, and the like. Use of such effects on a pocket clip in accordance with the invention provides a writing instrument with enhanced advertising or graphics displays on a writing instrument surface that will often be prominently visible when the writing instrument is clipped to a surface or material or when the writing instrument is being held by the user.

In one aspect of this invention, a writing instrument is provided that includes an elongated body having a length, an outer surface, a proximal end, and a distal end, and a clip extending along at least a portion of the length of the body. The clip includes an outwardly facing display surface comprising a lenticular image. The display surface can include a lenticular lens material insert positioned on a base portion of the clip and the lenticular lens material insert can be removably attached to the base portion of the clip, such as with at least one retaining clip. Alternatively, the lenticular lens material insert can be permanently attached to the clip.

The clip may also include at least one wall extending from the base portion, wherein the base portion is sized to accept the insert of lenticular lens material. The wall or walls may extends around the perimeter of the base portion to create a rim around the base portion of the clip that defines an inner rim area, and the lenticular lens material insert can have a surface area that is at least slightly smaller than the inner rim area. The lenticular lens material insert can have a thickness that is not greater than a height of the extending wall or walls so that the insert is at least slightly recessed relative to a top surface of the at least one wall.

In another aspect of the invention a writing instrument is provided, which includes an elongated body having a length, an outer surface, a proximal end, and a distal end, wherein the outer surface comprises a first display area, and a clip comprising a second display area extending along at least a portion of the length of the body. At least one of the first and second display areas comprises a lenticular lens material insert, which may be removably attached and/or interchangeable with other lenticular lens material inserts.

### BRIEF DESCRIPTION OF THE DRAWINGS

The present invention will be further explained with reference to the appended Figures, wherein like structure is referred to by like numerals throughout the several views, and wherein:

FIG. 1 is a perspective view of an exemplary embodiment of a writing instrument of the invention, including a clip displaying a graphic image on lenticular lens material;

FIG. 2 is a cross sectional view of the clip of FIG. 1 taken along section line 2-2, showing the lenticular lens material between extending walls of the clip;

FIG. 3 is a cross sectional view of the writing instrument of FIG. 1 taken along section line 3-3, showing a perpendicular view of the lenticular lens material of FIG. 2;

FIG. 4 is a perspective view of another exemplary embodiment of a clip of the present invention, including at least one channel for retaining a piece of lenticular lens material;

FIG. 5 is a cross-sectional view of the clip of FIG. 4, taken along section lines 5-5;

FIG. 6 is a cross-sectional view of another exemplary embodiment of a clip of the invention, including an inner area for enclosing a piece of lenticular lens material;

FIG. 7 is a perspective view of another exemplary embodiment of a writing instrument of the invention, including a removable clip assembly;

FIG. 8 is a perspective view of another exemplary embodiment of a writing instrument of the invention, including a recessed portion on the barrel of the instrument for displaying lenticular lens material;

FIG. 9 is a-cross-sectional view of another alternative view of the lenticular lens material taken along section line 3-3 of FIG. 1; and

FIG. 10 is a cross-sectional view of another lenticular lens material used in accordance with the clips of the present invention.

### DETAILED DESCRIPTION OF THE PREFERRED EMBODIMENTS

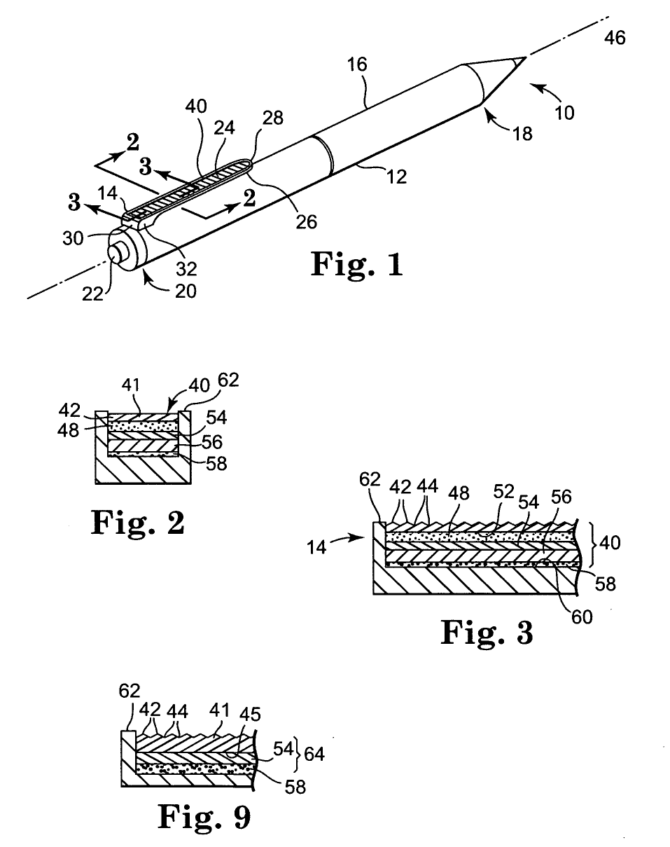

Referring now to the Figures, wherein the components are labeled with like numerals throughout the several Figures, and initially to FIG. 1, one preferred configuration of a writing instrument 10 in accordance with the present invention is shown. Writing instrument 10 generally includes an elongated cylindrical body or barrel 12 having a clip 14 extending from its outer surface 16. Writing instrument 10 has a proximal end 18 and a distal end 20, with the clip 14 extending from the outer surface 16 at an area generally adjacent to distal end 20. Writing instrument 10 is illustrated as a pen in the figure; however, it is understood that writing instrument 10 may instead be a mechanical pencil, marker, highlighter, or any other object that utilizes an extending clip of this type, such as a pocket-sized cutting tool, laser pointer, screwdriver, flashlight, and hand-held tire gauge, for example. Thus, references herein to a writing instrument or pen are intended to also apply to other instruments that can utilize the features of the invention. In order to provide a comfortable and functional gripping shape for the user, such an instrument will be generally elongated, such as in the shape of an elongated cylinder, although the instrument could have a different peripheral shape. For example, the outer surface of a barrel can include a series of flat surfaces around its circumference, such as a hexagonal shape, triangular shape, rectangular shape, or the like.

In the writing instrument 10 of FIG. 1, the cylindrical body 12 includes an inner area (not visible) that contains a writing material, such as ink, which may be enclosed within an elongated tube or ink cartridge. The instrument 10 further includes a button 22 at its distal end 20 for actuating the ink cartridge, such as for moving the cartridge between its retracted and extended positions. However, it is understood that a wide variety of devices and configurations are possible for movement of a cartridge or other writing material into and out of a cylindrical body, such as twisting of a two-piece barrel, sliding of a component (e.g., a pocket clip) along the length of the cylindrical body, and the like. Alternatively, the writing instrument may include a barrel having no moving parts enclosing the writing material, along with a removable pen cap. In this case, the removable pen cap may include a clip having a display surface with lenticular material. The clip of the present invention can be used with any configuration of a writing instrument in which it is desired to provide the user with the option to clip the writing instrument to another object, such as a pocket, a stack or pad of paper, a tool belt, a clipboard, file folders, and the like.

The clip 14 of FIG. 1 includes a top surface 24, an opposite bottom surface 26, a proximal end 28, and a distal end 30. In order for the clip 14 to function as a device for securing the writing instrument 10 to a pocket or the like, a portion of the clip 14 adjacent to the distal end 30 is secured to the outer surface 16 of the cylindrical body 12, while the portion of clip 14 closer to the proximal end 28 can have limited movement relative to the outer surface 16 (e.g., toward and away from the cylindrical body 12). At least a portion of the area extending from the distal end 30 toward the proximal end 28 is also unattached to the outer surface 16. The clip 14 further includes an attachment portion 32 extending from the bottom surface 26 that can be secured to the body 12 in a number of ways. For example, the attachment portion 32 can be secured to the body 12 with an adhesive or using mechanical attachment (e.g., protrusions that extend from the clip 14 into apertures in the body 12). For another example, the clip 14 can be integrally molded with the body 12. In any case, the clip 14 is preferably generally elongated and extends a sufficient distance along the length of the body 12 to allow for secure attachment of the writing instrument 10 to a pocket or the like. In that regard, the proximal end 28 of the clip 14 is preferably biased at least slightly toward the cylindrical body 12 so that it can move away from the body 12 when some material is being inserted between the body 12 and the clip 14 yet maintain at least enough pressure to secure or anchor the writing instrument 10 to that material for an extended time period.

The clip 14 further includes a graphic insert 40 as a portion of its top surface 24. The graphic insert 40 is preferably a lenticular lens material that is intended to provide certain desired changeable visual effects, such as for advertising purposes. The types of visual effects that can be provided include: flipping of the image, zooming in or zooming out of a particular image, 3-D or stereographic effects, full motion video or movement of an image, “morphing” or an illusion of metamorphosis from one image to another, and other effects that typically provide more than one image with a single piece of material. Typically, the desired effect can be achieved by simply changing the angle of viewing by the eyes relative to the lenticular material, either by moving the lenticular material, moving the object displaying lenticular material, and/or by the user moving his or her head to view the lenticular material from different angles.

In general, lenticular lens material can be used to create a certain visual effect, by selecting segments from visual images and interlacing the selected segments. Depending on the desired effect, the interlaced segments are mapped to the lenticular lens, and the printed interlaced images are then applied to the lenticular lens according to this mapping. The lenticular lenses generally include a transparent web or sheet that has a flat side or layer and a side with optical ridges and grooves formed by lenticules or convex lenses arranged side-by-side with the lenticules or optical ridges extending parallel to each other along the transparent web or sheet. To provide the desired visual effects, ink or another printing material is applied or printed directly to the flat side of the transparent web or sheet to form the interlaced segments. Alternatively, the ink may be printed on a layer other than the flat side of the web or sheet. For example, an image may be printed on the surface of a film or paper, then this paper can be put through another process to merge it with the lenticular lens material. Other ink printing arrangements are also possible. In any case, the resultant material can also be subject to a variety of other pre- and post-manufacturing processes, such as providing additional ink layers, die cutting smaller shapes from a large piece of material, adding a varnish layer, or the like, in order to achieve certain material properties (e.g., strength, water-proof, enhanced visual or graphic features, etc.) for the lenticular lens material.

One example of a graphic insert 40 comprising lenticular material used in accordance with the clip 14 of the invention is illustrated in the cross-sectional views of FIGS. 2 and 3, which are taken at generally perpendicular directions from each other. In particular, the insert 40 includes a lenticular lens material 41 comprising an outer surface layer of optical ridges 42 with alternating optical grooves 44. FIGS. 1-3 thus show the ridges 42 and grooves 44 extending in a direction generally perpendicular to a longitudinal axis 46 of writing instrument 10. However, the ridges 42 and grooves 44 may instead be generally parallel to the longitudinal axis 46, or the ridges 42 and grooves 44 may be angled relative to the ridges 42 and grooves 44. The different orientations will require different angles for viewing the changeable images. In this embodiment an ink layer is printed separately, then married to lenticular lens material after printing. In particular, an ink layer 54 is applied to a top surface of a substrate 56, which is applied to the flat surface of the lenticular lens material 41 via an adhesive layer 48. The graphic insert 40 further preferably includes a pressure sensitive adhesive (or other type of adhesive) 58 on the bottom of substrate 56.

Another example of a construction of a graphic insert 64 in accordance with the invention is illustrated in FIG. 9, as can be used with clips of the type described herein. In particular, graphic insert 64 includes a lenticular lens material 41 comprising an outer surface layer of optical ridges 42 with alternating optical grooves 44. The graphic insert 64 further includes a layer of ink 54 printed on the substantially flat side 45 of lens material 41 that is opposite the ridges 42 and grooves 44, and a layer of adhesive 58, which may be a pressure sensitive adhesive, for example, for bonding insert 64 on its corresponding clip.

During the manufacturing process, the lenticular lens material 41 is printed with corresponding interlaced images in conjunction with the appropriate mathematics of the lens material 41. The mathematics used preferably match both the lens material 41 and the outer layer including optical ridges 42 and also the shape of the piece on which it is mounted, such as would be the case if the recessed surface 60 of the clip 14 is not provided as a flat surface. For example, the entire clip 14 may be curved to be either concave or convex relative to the cylindrical body 12. Any such curvatures may occur in the direction that the clip 14 extends along the length of the body 12 (i.e., the length of the clip 14), or in the direction of the width of the clip 14. These curvatures could also be present along both the length and the width of the clip 14. If any curvatures are provided, the dimensions regarding the curvature will preferably be considered when preparing the images for printing.

In one exemplary embodiment of the invention, the clip 14 extends a sufficient distance along the length of the cylindrical body 12 to secure the writing instrument 10 to a material such as a shirt pocket. While the width of the clip 14 can be a width that is considerably smaller than its length, the clip 14 preferably has a relatively large width in order to maximize the surface area available for viewing. It is also contemplated that the clip can have a variety of shapes other than the generally rectangular shapes shown and described. For example, the clips of the invention may be circular, elliptical, triangular, or the like, where such shapes may not consist simply of a length and width, as when the clips are rectangular. Further, the clip may have an irregular shape or may take the shape of a logo, symbol, or the like. That is, in order to appreciate the visual effects provided by the lenticular material, it is preferable to maximize both the length and the width of clip 14 in order to provide a top surface 24 having a relatively large surface area. In that regard, the clip 14 can have a width that is smaller, larger, or equal to the diameter of the writing instrument to which it is attached. In any case, no dimension of the clip 14 should be so large that it interferes with the use or storage of the writing instrument to which it is attached.

As discussed above, the clip 14 includes a recessed surface 60. This surface 60 is either surrounded or partially surrounded by extending walls 62 in the form of a ridge or rim that extends from the recessed surface 60. The extending walls 62 provide a number of advantages to the clip 14 of FIG. 1. One such advantage is provided in an exemplary embodiment of the invention by positioning the surface 60 at a certain distance from the top of the extending walls 62. This distance between the surface 60 and the top of the walls 62 is preferably at least as large as the thickness of a graphic insert 40 that will be positioned on the clip 14, and is even more preferably at least slightly larger than the thickness of the graphic insert 40. In this way, the graphic insert 40 will be at least slightly recessed from the top of extending walls 62, thereby providing at least some protection to the optical ridges 42 from possible wear and scratching of their surfaces during handling of the writing instrument 10. Another advantage of the extending walls 62 is that they can provide protection to the edges of the graphic insert 40, which might otherwise be exposed. This protection can prevent damage to the edges during handling, can interfere with potential peeling of the graphic insert 40 away from recessed surface 60, and can also provide protection for clothing or other materials with which the insert 40 can come in contact. In this exemplary embodiment, the graphic insert 40 is provided with a selected size and shape to generally match the surface area of the recessed surface 60 and closely fit within the area between adjacent extending walls 62. However, it is possible that size and shape of the surface area of the insert is slightly smaller or considerably smaller than the surface area of the clip surface to which it will be attached, as desired.

In another exemplary embodiment, the distance between the recessed surface 60 and the top of the extending walls 62 is smaller than the thickness of a graphic insert that will be positioned on the recessed surface 60. In this way, the graphic insert 40 will be positioned with the optical ridges 42 (and possibly even the optical grooves 44 and other layers of the graphic insert 40) extending at least slightly above the top surface of the extending walls 62. This configuration may be particularly useful when the clip 14 is relatively thin such that it would compromise the clip strength to make an area of it even thinner for the graphic insert. That is, a recessed area for a thin clip 14 may compromise the strength of the clip 14 such that it is no longer strong enough for securing the writing instrument 10 to another material or object and/or the clip 14 would bend or permanently deform when moved in a direction away from the cylindrical body 12. Whether or not the distance that the recessed surface 60 is spaced from the top of the extending walls 62 is large enough to keep any portion of graphic insert 40 from extending above the top of walls 62, any slight recess of this area can also advantageously serve as a guide for accurate placement of a graphic insert on the clip 14 within the recessed portion.

In yet another exemplary embodiment (such as is illustrated with the clip 110 of FIG. 8), the clip 14 does not have a recessed area. In this case, the graphic insert 40 can simply be adhered or otherwise attached to surface 24 with the entire thickness of the graphic insert 40 positioned above the top surface 24. It may be desirable in this situation to provide a more aggressive adhesive layer 58 to prevent the graphic insert 40 from being peeled away from the top surface 24. A wide variety of adhesive materials can be used for the adhesive layer 58, such as hot melt adhesives, thermal adhesives, and the like. The graphic insert 40 may further include a liner that is placed over the adhesive that would be removable to expose the adhesive before placing the insert on the clip 14 (i.e., a “linered adhesive”). Alternatively, the material used for the adhesive layer 58 may not include such a liner (i.e., a “linerless adhesive”).

In the various embodiments of the invention, it is contemplated that the width and/or length of the graphic insert may be substantially the same size as a clip to which it is attached, or that the graphic insert can be larger or smaller than the corresponding width and/or length of a clip to which it is attached. For example, the graphic insert may extend beyond one or more edges of a clip base in order to maximize the surface area available for displaying lenticular material. In this case, the graphic insert preferably has sufficient structural integrity so that any portions that extend beyond the edge or edges of its corresponding clip are not easily damaged (e.g., bent or torn). Further, the graphic insert may itself comprise the clip such that no base clip portion is required. Again, the graphic insert in such a configuration should have sufficient structural integrity that it can function as a clip for its desired uses. This clip made entirely of the lenticular material may be formed by an operation such as thermoforming, for example.

As described above, one exemplary embodiment of the clip 14 of the invention includes a graphic insert 40 comprising an adhesive layer 58 for securing graphic insert 40 to clip 14. However, it is contemplated that the graphic insert 40 may have a different structure that does not require such an adhesive layer. Instead, graphic insert 40 may be integrally molded or formed as a part of the top surface 24 of clip 14. An example of such a configuration is illustrated as graphic insert or label 180 in FIG. 10. Insert 180 includes a lenticular lens material 182 comprising an outer surface layer of optical ridges 184 with alternating optical grooves 186. An ink layer 188 is printed (e.g., by reverse printing methods) on the bottom surface of lens material 182. An adhesive layer 190 (e.g., urethane) provides a bonding layer for attachment of a laminating film 192 to the structure. Laminating film 192 may comprise a bi-oriented polypropylene, such as treophan (i.e., a layered film) or pro paper (i.e., a homogenous film).

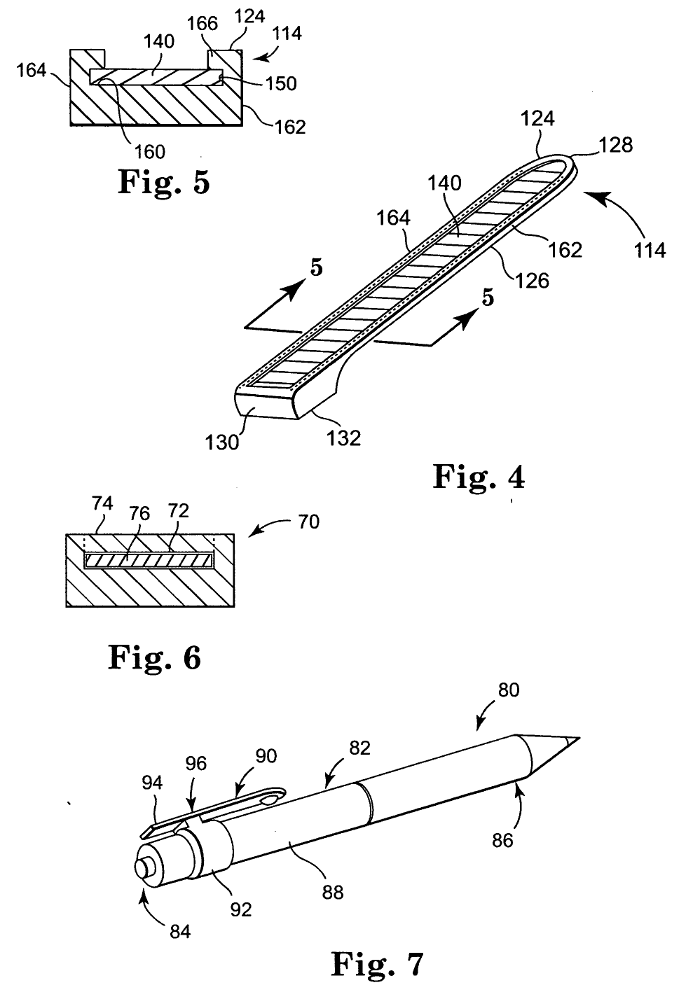

FIGS. 4 and 5 illustrate another exemplary embodiment of a clip 114 for use with a writing instrument in accordance with the invention. Clip 114 includes a top surface 124, a bottom surface 126, a proximal end 128, and a distal end 130. In order for the clip 114 to function as a device for securing a writing instrument to a pocket or the like, a portion of the clip 114 at the distal end 130 would be secured to the outer surface of a writing instrument, while the portion of clip 114 at proximal end 128 would be free to move relative to the outer surface of the writing instrument. In that regard, clip 114 further includes an attachment portion 132 adjacent to distal end 130 that extends from the bottom surface 126 and that can be secured to a writing instrument in a number of ways, as described above. Clip 114 further includes a channel 150 extending around at least a portion of its periphery below a portion of the top surface 124 for containing a graphic insert 140. As with the discussion above relative to graphic insert 40, graphic insert 140 preferably comprises a lenticular lens material having a changeable graphic image.

The channel 150 of FIGS. 4 and 5 includes a recessed surface 160 on its bottom side that is spaced from an overhanging portion of top surface 124 on its upper side. The surface 160 may be continuous, as shown, or may instead be discontinuous, such as may include a through hole or a complete break through the bottom surface of the structure. The overhanging portion of top surface 124 acts as a retaining clip 166 for securing the graphic insert 140 on the surface of the clip 114. The retaining clip 166 may be considered to be the portion of the top surface 124 that makes up the top portion of the channel 150. The retaining clip 166 preferably extends a distance over the top of the graphic insert 140 that is great enough to hold the graphic insert 140 securely on the surface of clip 114. At the same time, the retaining clip 166 should extend by as small of a distance as possible in order to maximize the amount of the top surface of graphic insert 140 that is visible. In the exemplary configuration of FIG. 4, the graphic insert 140 is held in place in channels 150 along opposite sides 162 and 164 of the clip 114. The areas along the proximal end 128 and the distal end 130 do not include such channels in this embodiment, although it is contemplated that one or both of these ends can additionally or alternatively include such a channel.

In order to position the graphic insert 140 within the channels 150, the graphic insert 140 is provided with a length that is slightly less than the length of recessed surface 160 between oppositely positioned channels. The graphic insert 140 can be slightly deformed or curved between two of its ends in order to decrease its effective length or width. One end of the graphic insert 140 can then be placed in a section of channel 150 (e.g., at the proximal end 128 of the clip 114), and then the other end of the graphic insert 140 can be slid into another section of channel 150 (e.g., at the distal end 130 of the clip 114). The graphic insert 140 is then released so that it can spring back to its original effective length, thereby being positioned on the recessed surface 160 and at least partially retained by the channels. Alternatively, the graphic insert 140 may be slid or snapped into the channels using another method, such as could be accomplished by providing an aperture on the clip 114 for insertion of the graphic insert 140. At this point, the retaining clips 166 of the channels 150 will hold the graphic insert 140 in place. While an adhesive layer can be used on the bottom side of the graphic insert 140, such an adhesive layer may not be necessary if the configuration of channels and/or retaining clips provides a sufficiently secure attachment for the graphic insert 140. It is also possible to use a repositionable pressure sensitive adhesive, if desired, to provide a more secure attachment while allowing for future removal of the graphic insert 140 from the clip 114. It is further possible to use other types of attachment methods, such as magnetic attachment and hook and loop attachments, for example.

A wide variety of configurations are possible for the positioning of channels around a portion of the periphery of the clip 114. For example, channels may be provided only in discrete areas, such as the areas adjacent to the proximal end 128 and the distal end 130. In another example, channels may be provided around the entire periphery of the clip 114. In yet another example, channels may be placed along opposite ends of the clip 114, or may be placed intermittently around the periphery of the clip 114. In any case, any retaining clip 166 should be spaced at a distance from surface 160 that is at least slightly larger than the thickness of a graphic insert 140 that is to be positioned therein. That is, the depth of the channels 150 should be large enough to accommodate the thickness of the graphic insert 140, but the depth is preferably not so large that the graphic insert 140 can move significantly within the channels 150 and/or relative to the clip 114.

FIG. 6 illustrates a cross sectional view of another exemplary embodiment of a clip 70 in accordance with the invention. This view is essentially taken as a cross-section showing the clip 70 across its shorter dimension (e.g., the width of the clip 70). Instead of having retaining clips, however, the clip 70 includes a pocket or opening 72 that extends along at least a portion of the length of the clip 70. The opening 72 is preferably accessible from at least one end or edge of the clip 70 to provide a space for insertion of a piece of lenticular lens material or graphic insert 76. In order to keep the material 76 from being dislodged or falling from the opening 72, it is further preferable that the opening 72 is only high and wide enough to allow insertion of the insert 76, with minimal clearance. It is also preferable that openings not be positioned on opposite sides of the clip 70, although if such oppositely positioned openings are used, some type of configuration, such as a stop, is preferably used to prevent the graphic insert 76 from falling from the clip 70. In particular, the opening 72 may further comprise a lip or ridge (not shown) for retaining the insert within the opening 72. In order to be able to view the insert 76 from the top of the clip 70, the area 74 immediately above the graphic insert 76 is preferably transparent or at least translucent. This area 74 may be molded as part of the clip 72 or it may be a separate piece that snaps or otherwise fits onto the clip 70 during assembly thereof, such as after placing the graphic insert 76 on the clip 70. It is also possible that the area 74 is provided with a layer of material over the insert 76 that prevents the grooves from being filled, then an additional layer of material in a liquid form that hardens to make a relatively clear section above the insert. Such a material may be provided as an epoxy or acrylic material, for example. The piece of material 76 is preferably sized to cover the area of the clip 70 that would be visible under the area 74 when it is inserted in the opening 72.

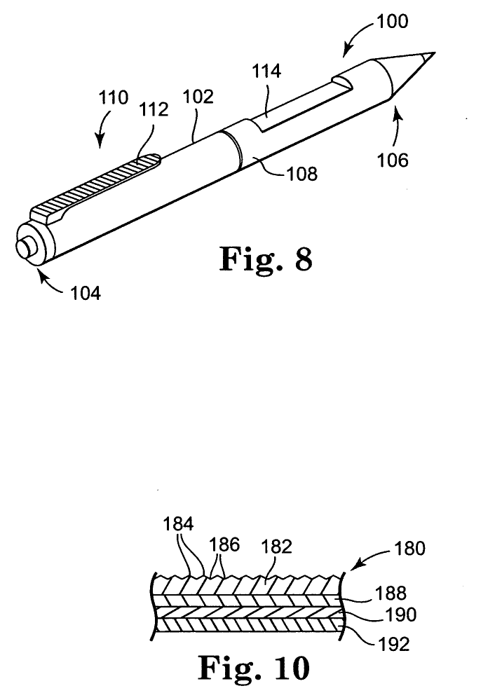

Another exemplary embodiment of a writing instrument 80 in accordance with the invention is illustrated in FIG. 7. Writing instrument 80 includes an elongated cylindrical body or barrel 82 having a distal end 84, a proximal end 86, an outer surface 88, and a clip or pocket clip assembly 90 secured to the outer surface 88. Writing instrument 80 can include any of the types of elongated instruments described above that utilize an extending clip. In this exemplary embodiment, the clip assembly 90 includes a clamping portion 92 surrounding at least a portion of outer surface 88 and a base portion 94 extending from the clamping portion 92. Base portion 94 includes a graphic insert 96 (not visible) as a portion of its top surface. The graphic insert 96 is preferably a lenticular lens material that is intended to provide certain desired changeable visual effects, such as for advertising purposes. The graphic insert 96 may include any of the features described herein relative to clips of the invention, including inserts that are integrally molded with a base portion and graphic inserts that are removeable and replaceable from a base portion, for example.

The clip 90 can be provided as part of an assembly (e.g., writing instrument 80), or may alternatively be provided as a separate item that can be used on any appropriately sized cylindrical instrument. To accomplish this, the clamping portion 92 of the clip 90 can be constructed as a ring with a fixed inner diameter, for example, that can slip over one end of a cylindrical instrument having a similarly sized outer diameter. Alternatively, the clamping portion 92 can have a variable diameter that can fit around a number of differently sized cylindrical instruments. Other types of attachments for clips are known in the art and can be used in place of the clamping portion 92 for the clip 90 of the invention.

FIG. 8 illustrates another exemplary embodiment of a writing instrument 100 in accordance with the invention. Writing instrument 100 includes an elongated cylindrical body or barrel 102 having a distal end 104, a proximal end 106, an outer surface 108, and a clip or pocket clip assembly 110 secured to the outer surface 108. In this exemplary embodiment, the clip 110 includes a graphic insert 112 as a portion of its top surface, which is preferably a lenticular lens material. The clip 110 preferably includes some type of fixation mechanism for removable attachment of the graphic insert 112 to its top surface (e.g., retaining clips or channels of the type described relative to FIGS. 4 and 5). The outer surface 108 of cylindrical body 102 also preferably includes at least one recessed portion 114. Recessed portion 114 preferably includes a surface area that is approximately the same size and shape as that of the graphic insert 112, and also includes some type of fixation mechanism for accepting a graphic insert on its top surface. Both fixation mechanisms are preferably designed to allow for removal and replacement of the graphic insert 112, as desired, although it is possible that graphic inserts are permanently affixed to both the clip 110 and the recessed portion 114. It is further contemplated that the area of an elongated body that is used for displaying a graphic insert can be flush with the surface of the elongated body. In this case, the graphic insert can be adhered or otherwise attached to the surface of the elongated body in at least one location.

As described, the writing instrument 100 includes two areas that are available for displaying information, which may optionally allow for interchangeable graphic inserts on a single writing instrument. Advantageously, writing instruments of the invention may be provided in kits that include multiple graphic inserts that can be removed and/or replaced by the user, as desired. It is possible, however, that the recessed portion 114 is differently sized and/or shaped from the area of the clip 110 on which the graphic insert is positioned such that different graphic inserts would need to be provided for each area.

In this embodiment of writing instrument 100, the lenticular lens material that is used for the graphic insert on recessed portion 114 may additionally be used as a grip material. Thus, the optical ridges and grooves should be positioned on the recessed portion to provide a gripping surface that provides resistance against slipping when a hand holds the writing instrument. The gripping surface may be made of a flexible material, or the surface may be rigid or semi-rigid. The gripping surface may extend around all or only a portion of the writing instrument in a continuous or discontinuous manner. The gripping surface material may be made by thermoforming, printing and die cutting from sheets or rolls of material, or in any of the various methods described herein relative to graphic inserts. Further, the gripping surface may be attached by injection molding of a lenticular material or attaching or adhering the graphic insert to the writing instrument by any of the various methods described herein relative to graphic inserts.

The present invention has now been described with reference to several embodiments thereof. The entire disclosure of any patent or patent application identified herein is hereby incorporated by reference. The foregoing detailed description and examples have been given for clarity of understanding only. No unnecessary limitations are to be understood therefrom. It will be apparent to those skilled in the art that many changes can be made in the embodiments described without departing from the scope of the invention. Thus, the scope of the present invention should not be limited to the structures described herein, but only by the structures described by the language of the claims and the equivalents of those structures.

1. An elongated instrument comprising:
a body having a length, an outer surface, a proximal end, and a distal end; and
a clip extending along at least a portion of the length of the body, the clip comprising an outwardly facing display surface comprising a lenticular image.

2. The instrument of claim 1, wherein the display surface comprises a lenticular lens material insert secured to a base portion of the clip.

3. The instrument of claim 2, wherein the lenticular lens material insert is removably attached to the base portion of the clip.

4. The instrument of claim 3, wherein the clip further comprises at least one retaining clip for removably attaching the lenticular lens material insert to the base portion of the clip.

5. The instrument of claim 2, wherein the lenticular lens material insert is permanently attached to the base portion of the clip.

6. The instrument of claim 2, wherein the clip further comprises at least one wall extending from the base portion, and wherein the base portion is sized to accept the lenticular lens material insert.

7. The instrument of claim 6, wherein the at least one wall extends around the perimeter of the base portion to form a continuous rim around the base portion of the clip that defines an inner rim area.

8. The instrument of claim 7, wherein the lenticular lens material insert has a surface area that is at least slightly smaller than the inner rim area.

9. The instrument of claim 6, wherein the lenticular lens material insert has a thickness that is not greater than a distance that the at least one wall extends from the base portion of the clip, so that the insert is at least slightly recessed relative to a top surface of the at least one wall.

10. The instrument of claim 6, wherein the lenticular lens material insert is positioned on the recessed base portion adjacent to the at least one wall.

11. The instrument of claim 1, wherein the lenticular image is integrally formed with the display surface as a lenticular lens.

12. The instrument of claim 3, wherein the clip further comprises:
an opening into which the lenticular lens material insert can be inserted; and
a top surface that is at least partially transparent to allow visibility of the lenticular lens material insert.

13. The instrument of claim 1, wherein a writing material is provided in an interior portion of the body.

14. The instrument of claim 1, wherein the clip comprises a lenticular material.

15. An elongated instrument comprising:
a body having a length, an outer surface, a proximal end, and a distal end, wherein the outer surface comprises at least one body display area; and
a clip extending along at least a portion of the length of the body, the clip comprising at least one clip display area;
wherein at least one of the body and clip display areas comprises a lenticular lens material insert.

16. The writing instrument of claim 15, wherein at least one lenticular lens material insert is removably attached to at least one of the body and clip display areas.

17. The writing instrument of claim 15, wherein the lenticular lens material insert is interchangeable between the body and clip display areas.

18. The writing instrument of claim 15, wherein the body comprises a plurality of body display areas.

19. The writing instrument of claim 15, wherein the at least one body display area comprises a gripping surface.

20. A clip for attachment to an elongated instrument, the clip comprising an outwardly facing display surface comprising a lenticular image.
